(19) United States
(12) Patent Application Publication
(10) Pub. No.: US 2007/0195803 A1
(43) Pub. Date: Aug. 23, 2007

(54) METHOD AND ARRANGEMENT DEVICE RELATING TO COMMUNICATION NETWORK

(76) Inventors: Christopher G. Lowery, Verbier (CH); Karl Ahmed, South Bucks (GB)

Correspondence Address: GAUTHIER & CONNORS, LLP, 225 FRANKLIN STREET, SUITE 2300, BOSTON, MA, 02110, US

(21) Appl. No.: 11/559,613

(22) Filed: Nov. 21, 2006

Related U.S. Application Data
(63) Continuation of application No. PCT/SE05/00739, filed on May 16, 2005.

(30) Foreign Application Priority Data
May 14, 2004 (SE) 0401266-2

(51) Int. Cl. H04L 12/56

(52) U.S. Cl. 370/401

(57) ABSTRACT

The present invention relates to a gateway for connecting a number of incoming analogous and/or digital inputs to a General Packet Radio Service (GPRS) based output. The gateway device comprises: at least one analogous and/or digital data interface for interfacing said inputs, a SIM card, with a specific IP address, an instruction set memory, a wireless transceiver, means for storing collating and managing data, and means for converting input data to GPRS or fixed line data.

### THE FIELD OF THE INVENTION

The present invention relates to an arrangement device and method in a data communications network and especially a GPRS based communications network. The invention also relates to a GPRS based network.

### THE BACKGROUND OF THE INVENTION

Mobile e-mail for mobile computers e.g. laptops, for many years considered the “Killer Application” for mobile data services has not materialized due to slow and inefficient mobile networks.

The clear indication of this is that no more than 5% of, for example, GSM users, presently use it to send data. The predictions of an increase to 20% by 2005, with the roll-out of GPRS networks and the Market Prediction of 150 million mobile data users in 2003, on these G2.5 networks, clearly indicates that the market is expected to come to life with increased speed. However the G2.5 and G3 networks will require new user hardware, will be considerably slower than anticipated and will be more expensive than existing networks.

The General Packet Radio Service (GPRS) is an existing non-voice value added service that allows information to be sent and received across a mobile telephone network. It supplements Circuit Switched Data and Short Message Service (SMS).

GPRS involves overlaying a packet based air interface on the existing circuit switched GSM network. This gives the user an option to use a packet-based data service. To supplement a circuit switched network architecture with packet switching is quite a major upgrade. The GPRS standard is delivered network operators needing only to add a couple of new infrastructure nodes and making a software upgrade to some existing network elements.

With GPRS, the information is split into separate but related “packets” before being transmitted and reassembled at the receiving end.

GPRS has several unique features, which can be summarized as:
Speed: Theoretical maximum speeds of up to 171.2 kilobits per second (kbps) are achievable with GPRS using all eight timeslots at the same time. This is about three times as fast as the data transmission speeds possible over today's fixed telecommunications networks and ten times as fast as current Circuit Switched Data services on GSM networks. By allowing information to be transmitted more quickly, immediately and efficiently across the mobile network, GPRS may well be a relatively less costly mobile data service compared to SMS and Circuit Switched Data.
Immediacy: GPRS facilitates instant connections whereby information can be sent or received immediately as the need arises, subject to radio coverage.
Applications: GPRS facilitates several new applications, by fully enabling, e.g. the Internet applications over the mobile network, file transfer and home automation.

Many governments, including the European Union commission, have proposed legislation to improve management and conservation of precious natural resources. In reality, this can only be done by the implementation of a system of remote automated metering for water, electricity and gas. Attempts have been made to introduce such a system using GPRS. However, GPRS is not economically viable to monitor millions of utility meters over wide geographical areas. However, at the present time there is no other data only network available for requirements of this type.

WO02093811 describes an interface device for interfacing between a PLMN network and a non-PLMN network. The PLMN network is configured to recognize cellular base stations as nodes thereof through which to mediate connections to cellular mobile devices. The non-PLMN networks each comprising a plurality of access points for mediating connections to network compatible mobile devices, and for which the network compatible mobile devices are not required to be cellular devices. The interface device is configured as a node of the PLMN network to appear to the PLMN network as a standard cellular base station, and comprises functionality to make non-cellular devices connecting to the non-PLMN network and attempting to access the PLMN network through the non-PLMN network appear as cellular devices to the PLMN network.

### SUMMARY OF THE INVENTION

Thus, there is a need for a novel arrangement and for a communications network benefiting from GPRS advantages, whilst incorporating other features, to improve performance and reduce costs.

Consequently, according to a first aspect of the invention a specially developed novel GPRS device, the gateway device, is provided that can be used to interface GPRS to any of presently available and future standards, such as: Wireless Fidelity (WiFi), Bluetooth, Infrared, RS232, TCP/IP (Transport layer Protocol/Internet Protocol), VolP (Voice IP), Low power radio (LPR) and Public Switched Telephone Network (PSTN) i.e. dial tone, etc.

The gateway device will allow a two-way Internet protocol (IP) tunnel to be setup between any devices connected to the gateway and any service connected to a server. The data travelling between the device and server can be encrypted and compressed, thus providing an increased speed of transmission, reduced cost of transmission and increased security of transmission.

The gateway device is compatible with all current standards of interface and can translate from and to these standards, including, but not limited to, WiFi, Bluetooth, Infrared, TCP/IP, VolP, LPR and PSTN (i.e. dial tone).

The commercially available devices do not allow a translation of standards and can only offer one standard at any time. Most of the interactive wireless applications depend on a true two-way communication tunnel to be setup. This is not feasible at the present due to security, latency and network resource.

According to the second aspect of the invention the gateway device can receive, store, collate, manage and retransmit many simultaneous batches of data, from many data monitoring devices, e.g. utility meters, thus acting as a hub, or concentrator of data, between many data monitoring devices and a server.

This method can be referred to as a remote automated measuring system, permitting the collection of value measurements from many data monitoring devices, transmitted to the gateway device by one of many different signals, e.g. from low power radio transmitters attached to many utility meters, then stored, collated, managed and retransmitted to a server by one of many different signals, e.g. GPRS,

In this method, many gateway devices can be interconnected to create a single network, thus permitting the structuring of a remote automated measuring system over a wide geographical area, each gateway device connected to many data monitoring devices and then interconnected with many other gateway devices.

Also in this method, all data monitoring devices and gateway devices are allocated a unique address, thus permitting correct correlation of the data and interrogation of any data monitoring or gateway device from the server.

According to the third aspect of the invention a network is provided allowing a two-way Internet protocol (IP) tunnel to be setup between any device installed with a special SIM card and any service connected to a server. The data travelling between the device and server can be encrypted and compressed, thus providing an increased speed of transmission, reduced cost of transmission and increased security of transmission.

According to the fourth aspect of the invention, the data can then be retransmitted from the server in IP form over the public Internet and provided to the ultimate customer in the form of a web based display.

The network is compatible with all current standards of interface and can translate from and to these standards, e.g. WiFi, Bluetooth, Infrared LPR or TCP/IP.

The current offering by most operators allowing GPRS connectivity is that they are only offering a one-way transmission service, from the device to the server and not the other way. Most of the interactive wireless applications depend on a true two-way communication tunnel to be setup. This is not feasible at the present due to security, latency and network resource.

Accordingly, the gateway device of the invention and the possibility of multiple interconnection of devices to create a data network, very much like a cellular network, overcome the above problems and provide a true two-way secure, real time, efficient and multi-standard connection.

The arrangement of the invention overcomes above problems and provides a true two-way secure, real time and efficient connection.

Thus, additional objects of the invention are:
To create a useful and economical means by which the “typical user” could receive and send data quickly through the existing mobile networks.
The service for mass market potential is to be applicable for the users of the existing software.
To provide a new mobile technology and/or a custom made mobile device for a proprietary technology.
To provide a means by which many small data monitoring devices can be managed as a group of devices and many gateway devices can be interconnected to create a data network.
To provide a facility for users, such as utilities companies, to monitor and manage many remote devices, such as water meters, in order to better manage customer accounts and improve conservation of precious natural resources.
The implementation and use of the service should be as simple and transparent to the user as possible and should not deviate from their usual routines and practices that they already use.

Moreover, the basic network criteria include:
The access to the network should work from all mobile networks, preferably from all networks.
Be cost effective.
Be money saving for the user, both from a mobile originated connection as well as fixed.
Be available globally.
Be of value to the world community in general.
Be safer than using GSM.

As so often is the case, the end result of development exceeds the initial criteria. In this case the gateway device was initially developed to improve data transfer over mobile networks but the network will equally improve transfer of data, also has been tested for access over GPRS (2.5G) with equally successful speed increase as on present mobile networks and will permit the construction of the first true data and Machine to Machine (M2M) only network.

Thus, according to first aspect of the invention a gateway device is provided for connecting a number of incoming analogous and/or digital data inputs to a General Packet Radio Service (GPRS) based output. The gateway device comprises: at least one analogous and/or digital data interface for interfacing the inputs, a SIM card, with a specific IP address, an instruction set memory, a wireless transceiver, means for storing, collating and managing data, and means for converting input data to GPRS or fixed line data. Preferably, the input is one or several of a group of PSTN or voice IP connection, a WiFi, Bluetooth, IR, LPR connection RS 232 or TCP/IP. Preferably, the device is a client/server device using an instruction set, which drives the GPRS or other type of device connected to a network. The gateway device may comprise means for one or several of receiving, storing, collating, managing and retransmitting a number of simultaneous batches of data. Preferably, the data is provided from monitoring devices. In one embodiment the monitoring devices comprises utility meters. The gateway device may comprise means for collecting data from a number of data monitoring devices in same or different signal formats and to interconnecting to one or several gateway devices and a server to create a data network over a wide geographical area. In another embodiment the gateway device is designed and optimized for sending and receiving data through a GPRS connection, in particular all common mobile connections, such as GSM, GPRS, CDMA, TDMA, ISDN, E1 and 10 base T. The device may operate with fixed network connections.

Preferably, the gateway device installs a dedicated client instruction set in order to connect to other gateway devices, servers and the network. The instruction set communicates with a network hub server and together they transform the way data is being handled, sent and received. In one preferred embodiment, the instruction set comprises: a reconfiguration part, a compression part, a selector part, a transmission part, an auto Restore function, a module for collecting, storing and managing data, and a module for interconnection with other gateway devices. The reconfiguration part is provided for reconfiguration of transport packets, their size and number. The gateway device may further comprise means for encrypting output data, and means for compressing data. The selector part is provided for prioritizing content to be sent. The selector part optimizes the use of time whilst connected by sending the smallest packets first and the largest files last. The transmission part is provided for full duplex transmission. The auto restore function is provided to monitor and control what data has been sent and to resend, where necessary, any data which may have been lost or corrupted in transit.

The gateway device may comprise means for encryption between two units through a communication channel.

Preferably, the gateway device comprises addition modules for enabling GPRS on a GSM network, a first module is a Gateway GPRS Service Node (GGSN), a second module is a Serving GPRS Service Node (SGSN). The GGSN acts as a gateway between the GPRS network and Public Data Networks. The SGSN provides packet routing to and from the SGSN service area for all users in that service area.

The gateway device may comprise Packet Control Units, hosted in Base Station Subsystems, mobility management to locate a GPRS Mobile Station, an air interface for packet traffic, security features such as ciphering and GPRS specific signaling.

The gateway device may comprise IP tunneling to encapsulate an IP datagram within IP datagrams, which allows datagrams destined for one IP address to be wrapped and redirected to another IP address.

In the gateway device an outer IP header may be added before an original IP header, and between them are any other headers for the path, such as security headers specific to the tunnel configuration, the outer IP header Source and Destination identify the “endpoints” of the tunnel. The inner IP header Source and Destination identify the original sender and recipient of the datagram.

The invention also relates to a network comprising many gateway device as described earlier, which collects, stores, collates and retransmit data from a number of data monitoring devices to one or several of gateway devices and/or servers.

The invention also relates to a server for incorporation in the above mentioned network, comprising means to allocate unique addresses to all gateway devices and subsequently to all data monitoring devices to facilitate data management from every data monitoring device. The server may comprise means for interrogation by an end user to seek the data from all or any gateway device or any data monitoring device connected to the gateway device, to obtain current value measurements for control and management. The server may comprise means for automatically instructing all gateway devices to read the value measurements of all data monitoring devices at given intervals to transmit data to an end user for control and management.

The invention also relates to a method of assisting in the monitoring, management and conservation of data by combining a collection of data in a number of gateway devices as described above, in different signal formats from one or several data monitoring devices, which are interconnected to one or several gateway devices and servers to create a data only network over a wide geographical area. For a remote automated measuring system, the method comprises permitting the collection of value measurements from the data monitoring devices, transmitted to the gateway device by one of many different signals from transmitters attached to a number of utility meters, then stored, managed and retransmitted to a server by one of many different signals, e.g. GPRS. The method may further comprise other remote automated measuring systems, including vehicle telematics, monitoring of temperatures, movement, sound, security geofencing, surveillance from remote cameras and other measurable data values in order to improve other environmental and security issues of growing worldly importance.

The invention also relates to a network comprising a GPRS Device and a Server accessing a GPRS network using a dedicated link and/or Internet. The GPRS device comprises a SIM card and an application to provide security and compression when transmitting by means of a wireless device, the Server comprising costumer control devices loaded with corresponding applications to provide security and compression.

The network may comprise means for transmitting data in IP form over Internet from the server to the customer in a manner which facilitates management from a web based display.

According to a second aspect of the invention, ability of the gateway device to collect data from many data monitoring devices and to interconnect to many other gateway devices to create a data only network over a wide geographical area.

According to a third aspect of the invention a network is provided, comprising a GPRS Device and a Server accessing a GPRS network using a dedicated link and/or Internet. The GPRS device comprises a SIM card and an application to provide security and compression when transmitting by means of a wireless device, the Server comprising costumer control devices loaded with corresponding applications to provide security and compression.

According to a fourth aspect of the invention, ability to retransmit the data from the server in IP form over the public Internet and display it to the ultimate customer in the form of a web based display.

According to yet another aspect, a remote automated measuring system is provided comprising a group of data monitors each equipped with radio transmitters capable of sending a radio signal containing measurement data and a server connected to a communications network. The system comprises at least one gateway equipped with means for receiving radio signals from the monitors and transmitting the data to the server via a communication network and then to a user in IP form. In the system, the information is managed on a web based display over the public Internet.

### SHORT DESCRIPTION OF THE DRAWINGS

In the following the invention will be described in a non-limiting way and in more detail with reference to exemplary embodiments illustrated in the enclosed drawings, in which:

FIG. 1 is a block diagram illustrating a gateway device according to the first aspect of the invention,

FIG. 2 is a block diagram illustrating a network according to the second aspect of the invention,

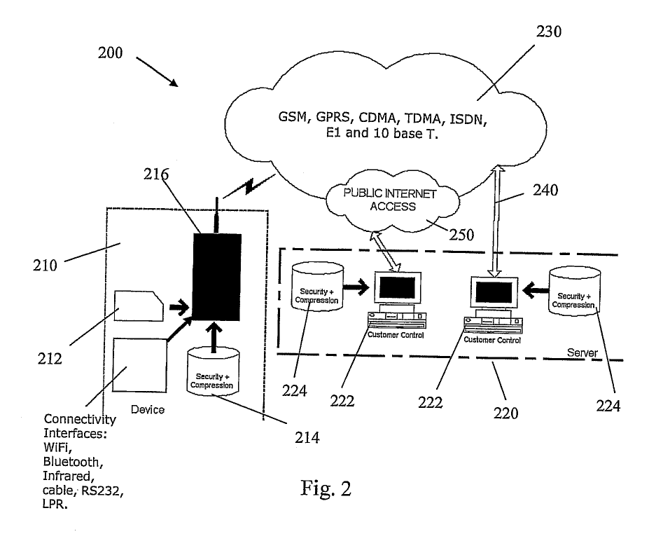

FIG. 3 is a block diagram illustrating modules involved for operation of a device according to the invention,

FIG. 4 is a block diagram illustrating IP tunnelling in a virtual network,

FIG. 5 is a block diagram showing how the route is pre-planned prior to transmission of data,

FIG. 6 is a block diagram illustrating an application employing a device according to the invention,

FIG. 7 is a diagram illustrating a gateway according to the invention connected to several different monitors,

FIG. 8 illustrates in a block diagram how the gateways can be interconnected using any of the interfaces, and

FIG. 9 shows diagrammatically how information collected by the data monitors can be viewed by third parties.

### DETAILED DESCRIPTION OF THE PREFERRED EMBODIMENTS

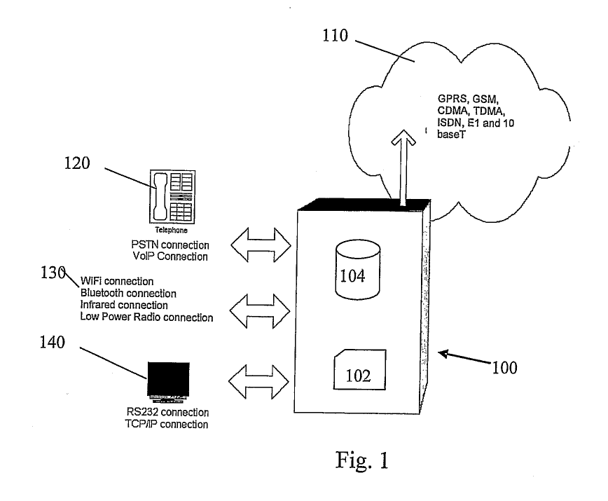

Referring to the FIG. 1, the gateway device 100 according to a preferred embodiment of the invention comprises several interfaces 120, 130 and 140 that can be translated into GPRS. The gateway may be incorporated with a special SIM card 102 and software 104, which can provide security and compression, The SIM is a GPRS only enabled card and is of a special series that has a higher priority of data transmission whilst on the network. The output from the gateway device, i.e. the input from the interfaces is translated into GPRS and transmitted to a GPRS able network 110. According to this particular embodiment the interfaces comprise a group of PSTN or voice IP connection 120, a WiFi/Bluetooth/IR/LPR connection 130 and RS 232 or TCP/IP 140.

The gateway device 100 is a client/server device using an instruction set, which converts and drives data through a GPRS network. It is specifically designed and optimized for sending and receiving data through a GPRS connection, in particular all common mobile and fixed line connections such as GSM, GPRS, CDMA, TDMA, ISDN, E1, 10 baseT, etc.

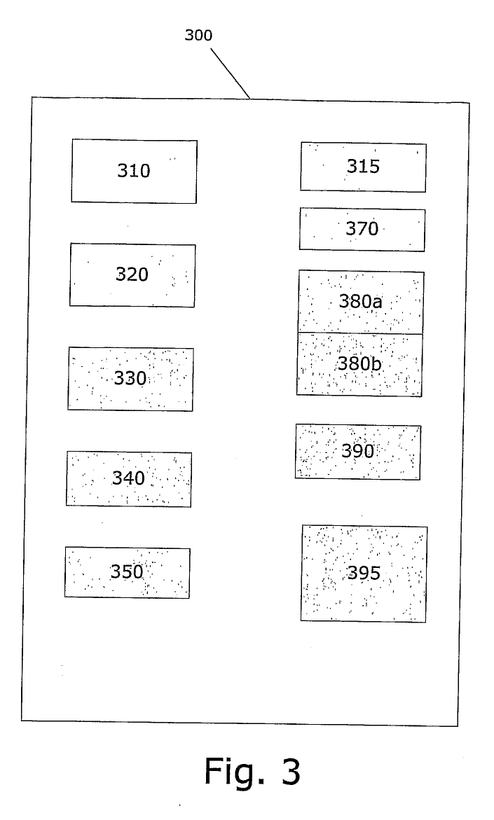

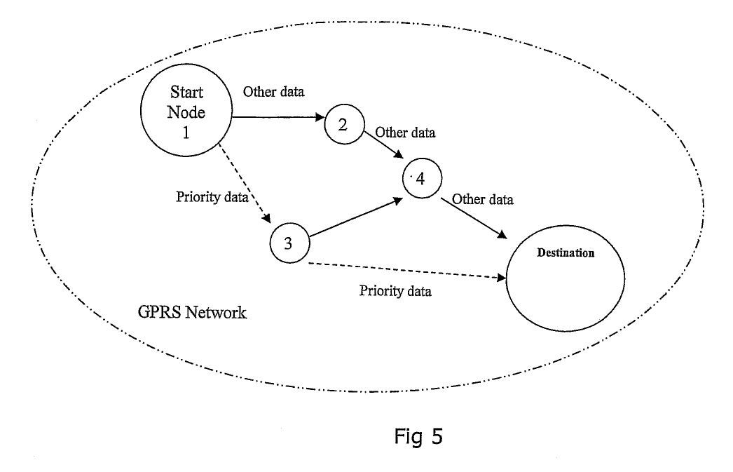

The client/server design of the network means that the device only needs to install a dedicated client instruction set 300, shown in the block diagram of FIG. 3, in the device in order to connect to the network. The gateway client software communicates with the network hub servers and together they transform the way data is being handled, sent and received. To achieve this increase in efficiency a number of technologies are used. Main ones are:
Reconfiguration module 310, for routing of transport packets. This feature reduces the latency time for the data to reach the destination. The entire route is known prior to the outset of the journey. Instead of getting the next hop details from each node as the data hops through the network, this module already plans and opens the necessary channels to send the data via the fastest or the most applicable route necessary to carry out the application. See FIG. 5. FIG. 5 illustrates a GPRS network 500 in which different sets of data are routed through the network from a start node 510 to a destination 520. In this case the data sets are priority data 530 and other (less priority) data 540. The entire route is known prior to the outset transmission, i.e. the nodes 1-destination and the connections between the nodes. Thus, instead of the traditional way of obtaining the next hop details from each node when transmitting data through the network, the reconfiguration module 310 already has planned the necessary channels to send the data via the fastest or the most applicable route to carry out the application. Here the priority data is routed through node 3, while other data is routed through nodes 2 and 4.
Compression module 320, a series of highly sophisticated compression technologies. This function compresses and reduces the size of the actual data being sent.
Selector 330, for prioritizing content to be sent. This function optimizes the use of time whilst connected by sending the smallest packets first and the largest files last. In a store and forward or non-priority transmission, the packets may be re-arranged to speed transmission and utilize network bandwidth more effectively.
Transmission module 340, for full duplex transmission. The unique ability of the gateway to send and receive data at the same time saves valuable time, network capacity and cost.
Auto Restore function 350. This function is particularly valuable for users that use the gateway device such as GPRS. In the event of an interruption in communications, the software automatically resends data and attachments from the last data packet point where the connection was dropped. This is done by keeping data logs on both sides allows this functionality.
According to one embodiment modules 315 comprising sub modules is arranged for collecting, storing and managing data.
Additional modules for interconnection with other gateway devices may also be incorporated.

Mobile connections are regularly subject to disruptions that terminate the connection and when this happens in the middle of sending and/or receiving data, it is necessary to reconnect and start the process all over again. The unique Auto Restore function of the gateway device enables data transfer to start at the point of disruption, saving a great deal of time and costs over and above the already fast transmission times.

With these and other, important but less significant features, the network according to the invention reduces the total size and the method of transmitting the data being sent and received. This is achieved using the compression function. As a consequence, the time it takes to send and receive data, such as e-mails, can take only one tenth of the time it would otherwise take.

The system of the invention provides high security. The invention can employ several types of security systems, which can be obtained from specialist suppliers.

Enabling GPRS on a GSM network requires the addition of two core modules, a Gateway GPRS Service Node (GGSN) 380a and the Serving GPRS Service Node (SGSN) 380b.

As the word Gateway in its name suggests, the GGSN acts as a gateway between the GPRS network and Public Data Networks such as IP and X.25. GGSNs also connect to other GPRS networks to facilitate GPRS roaming. The Serving GPRS Support Node (SGSN) provides packet routing to and from the SGSN service area for all users in that service area.

In addition to adding multiple GPRS nodes and a GPRS backbone, some other technical changes that need to be added to a GSM network to implement a GPRS service. These include the addition of Packet Control Units; often hosted in the Base Station Subsystems, mobility management to locate the GPRS Mobile Station, a new air interface for packet traffic, new security features such as ciphering and new GPRS specific signaling.

Presently the state of the art for extranet encryption boils down to two competing approaches: Secure Sockets Layer (SSL) and so-called “tunneling” protocols, principally PPTP and IPsec.

SSL, created by NETSCAPE to secure web-based credit card transactions, is also useful for extranets, especially those that resemble electronic commerce applications. Shopping carts and order entry systems are increasingly familiar uses for SSL, which is in play whenever your browser points to a URL beginning with https://, instead of plain old (non-secure) http://domain.com.

Tunneling is a better answer than SSL when a party needs to make confidential all communications between two end points, as is frequently required on an extranet. As well, when a party wants to let users roam between multiple Web servers each of which houses confidential information, without making them all SSL servers, tunneling is the solution.

Simply put: SSL makes sense for the occasional transaction, whereas tunneling creates a virtual private network (VPN), i.e. a company-confidential WAN along the Internet, or a regular data collection network over a wide geographical area.

Technically, it is the process of putting one packet inside another. Recalling that packets are the chunks of information into which all Internet messages get chopped, tunneling can be thought of as the act of encapsulating ordinary (non-secure) IP packets inside of encrypted (secure) IP packets.

It is sometimes more useful to think of tunneling in a less literal sense, namely, as a “tunnel” of privacy between two end-points connected by a public (non-secure) channel. This is often the Internet, but it could equally be the cellular telephone network. In a hide-in-plain-sight fashion, tunneling provides privacy by encrypting everything that goes into and comes out of a secure tunnel.

IP tunneling (IP encapsulation) is a technique to encapsulate IP datagram within IP datagrams, which allows datagrams destined for one IP address to be wrapped and redirected to another IP address. IP encapsulation is now commonly used in Extranet, Mobile-IP, IP-Multicast, tunneled host or network.

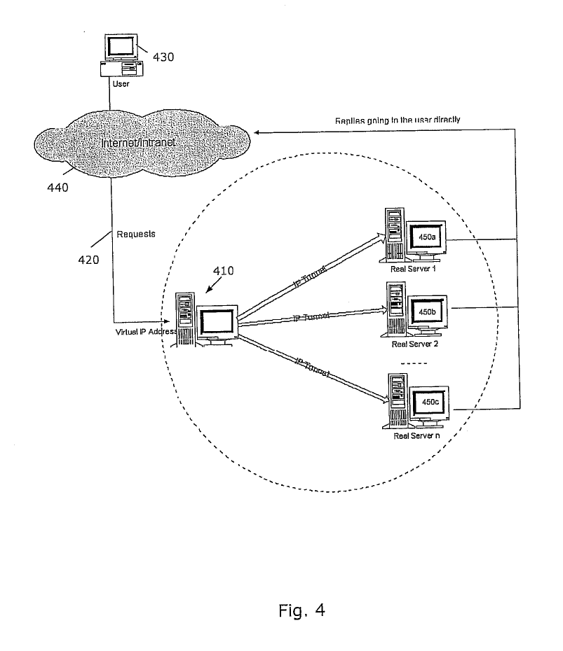

The Gateway device 300 comprises a module 390 for IP tunneling. The concept of IP tunneling is illustrated in FIG. 4.

The most different issue with the virtual server via IP tunneling to that of virtual server via NAT is that a load balancer 410 sends requests 420 from a user 430 received through Internet/intranet 440 to real servers 450a-450c through IP tunnel in the former, and the load balancer sends request to real servers via network address translation in the latter.

The IP in IP encapsulation Protocol/Payload number 4 has long been used to bridge portions of the Internet, which have disjoint capabilities or policies. These are the techniques used for joining a large mobile network, and also by early implementations of IP Security protocols.

Use of IP in IP encapsulation differs from later tunneling techniques (for example, protocol numbers 98, 94 [IDM91a], 53[swlPe], and 47) in that it does not insert its own special glue header between IP headers. Instead, the original unadorned IP Header is retained, and simply wrapped in another standard IP header.

The encapsulation technique is simple. An outer IP header is added before the original IP header. Between them are any other headers for the path, such as security headers specific to the tunnel configuration.

The outer IP header Source and Destination identify the “endpoints” of the tunnel. The inner IP header Source and Destination identify the original sender and recipient of the datagram.

Thus, the IP tunnel is a guaranteed way of opening a dedicated channel between the device and server

Referring now to FIG. 3, illustrating a network 200 according to the second aspect of the invention, the Network 200 comprises a GPRS Device 210 (as described earlier) and a Server 220 accessing the GPRS network 230 using a dedicated link 240 or via the Internet 250.

The GPRS device 210 has been fitted with a special SIM card 212 and an application 214 to provide security and compression when transmitting by means of a wireless device 216. The Server 220 comprising costumer control devices 222 is also loaded with corresponding applications 224 to provide security and compression.

According to one preferred embodiment, the invention concerns remote automated systems which permit the reading of data monitors and the transfer of the relevant information using existing telephone network infrastructure.

To this effect, the invention proposes an overlay structure comprising a group of data monitors incorporating radio transmitters capable of transmitting a radio signal containing the reading from a data monitor up to, for example a maximum of 50 km and a server connected to any telephone network. By the incorporation of at least one gateway device which can be installed on an existing mobile or terrestrial aerial mast and which is equipped with a gateway as described earlier of receiving and interpreting radio signals coming from a large number of data monitors and transmitting this information to the server via any telephone network in IP form thus permitting the user to monitor and manage the data on a web based display.

In particular the structure can contain many gateway devices and in this case, each gateway device is attributed to a sub-group of data monitors located in the same zone which can have a radius of for example 50 km.

In addition, each gateway device is allocated a fixed IP or unique address, so that it can send or receive information at any time, without requiring any start up procedure or seek and report cycles.

In addition each gateway device can have a memory capacity of, for example up to 64000 data monitor addresses.

In addition, the gateway device can be installed on the aerial masts of existing GSM or terrestrial networks, building locations, governmental owned so that planning permission is simplified. Additionally, by virtue of such installation of the gateway device, coverage of mobile telephone network connectivity is highly increased.

Moreover, by virtue of such installation of the gateway device, reception of data from the data monitors is highly improved. In addition, transmission from the gateway device can be effected by either the mobile telephone network or by the terrestrial network to which the aerial masts are connected. The data can be transmitted to the user by IP and can be managed on a web based management display through the public Internet which avoids the requirement of any enterprise IT resources.

The advantages of such a structure are to allow the centralization of information from up to 64,000 data monitors in a zone of up to 50 km radius at the level of a single gateway device. The gateway device can then send all the collected information to the server in a single telephone communication over existing telephone networks in IP form which can be easily interpreted and managed.

The radius of radio transmission can be increased by increasing the power output of both the transmitters and transceivers. Increased memory capacity of the gateway device over the relay may be accomplished by using an operating system, such as Linux. The allocation of a fixed IP address or unique identity to each gateway device can be achieved by changing network parameters from the user's web based display management system. The web based management system is derived from as a subset of other industry standard systems, i.e. using “.net” etc

The improvement in coverage of the mobile telephone network is achieved by overlaying the cellular connectivity of the gateway device onto the existing infrastructure of aerial masts or similar enhanced points of reception. In practice this requires that the gateway devices are fixed to the aerial masts of the existing GSM networks of one or more Mobile Network Operator and/or to installations of terrestrial operators, in accordance with a coverage map designed to provide optimum network coverage over the designated territory.

This method of installation will also provide enhanced reception by the gateway device of incoming data from the data monitor.

Furthermore, connection from the gateway device to the GSM, terrestrial or other network can be achieved either by the installation of a SIM, or similar means of GSM transmission, or by hard wiring the gateway device directly into the network connection inlaid into the aerial mast and/or directly into the terrestrial connection.

The option of connecting to terrestrial networks is provided by the same system of installation, since all, or most aerial GSM masts are connected directly into a terrestrial network and thus the gateway device can be easily connected into that network.

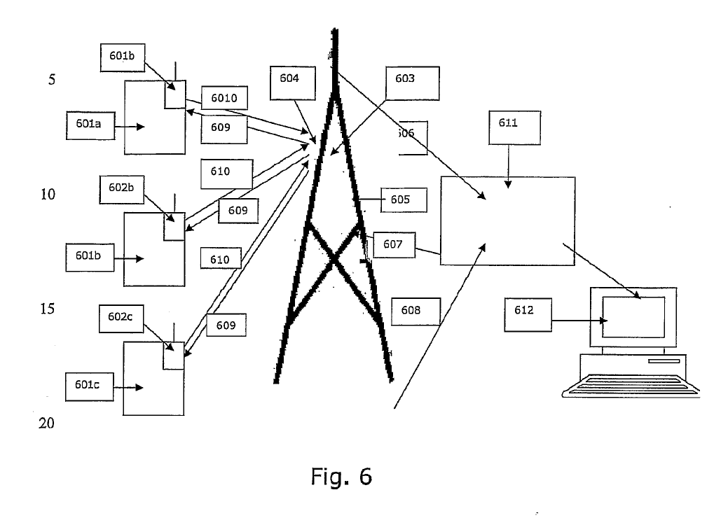

FIG. 6 represents an overlay structure of a network according to the present invention.

In this drawing, the structure shown comprises several data monitors 601a, 601b, and 601c each equipped with radio-transmitters 602a, 602b & 602c. A gateway device 603 is located within, e.g. 50 km., of the data monitors 601a, 601b & 601c. The gateway device 603 contains a radio-transmitter modem 604 which can exchange information with each radio-transmitter 602a, 602b & 602c, memory capacity 605 and a ubiquitous telephone modem 606. The gateway device can be located on an aerial mast so that the telephone modem 606 can communicate via a mobile telephone network 607 or via a terrestrial network 608 with a server 611.

The radio-transmitter modem 604 of gateway device 603 has a maximum range of between e.g. 10 m and 50 km permitting it to establish a radio connection with all of the radio-transmitters 602a, 602b & 602c of the data monitors 601a, 601b & 601c. Each radio-transmission modem is identified by a single unique address. All of the addresses in the group are recorded in the memory 605 of the gateway device 603. Up to e.g. 64000 addresses can be recorded in the memory 605. The gateway device 603 can therefore interrogate each data monitor 601a, 601b or 601c by sending a radio signal request 609. The interrogated data monitor 601a, 601b or 601c sends back a radio signal 610 containing both the address and the reading of the monitor. The gateway device 603 stores the data readings corresponding to the addresses of data monitors 601a, 601b or 601c in its memory 605. The gateway device 603 is also identified by a fixed IP address, which for example is allocated by the user from his web based management display 612 via the server 611 and which never changes.

The server 611 connected to the networks 607 and 608 and to the web based management system contains a list of data monitors, each of which is associated with an address in the gateway device and possibly other information, for example, in the case of utility meters, the details of the subscriber. The server 611 can receive, via the telephone networks 607 and 608 from the web based management system 612 in IP form requests from external companies concerning the level of consumption of a subscriber.

In this example, when the server 611 receives such a request, it identifies the meter concerned, for example the meter 601a, and it interrogates the corresponding gateway device, in this case the gateway device 603. The server 611 transmits to gateway device 603 a request for information concerning meter 601a. Because the gateway device 603 has a unique permanent fixed IP address, the server can identify it and dialogue with at any time and the user can manage this process on his web based display.

The gateway device 603 receives this request and treats it. It identifies the meter 601a by means of its address and establishes a radio channel with it. The gateway device 603 sends a request signal 609 to meter 601a which responds with a signal 610 containing the meter reading. The gateway device 603 sends the meter reading data to the server 611, either by a mobile or terrestrial telephone network. The server 611 sends the data to the company in IP form to be managed on a web based display.

In an exemplary application, the residents of a group of apartments can sign up for a subscription with a company, for example an electricity company. Each apartment is furnished with a meter 601a, 601b or 601c which continually registers the amount of electricity consumed. A gateway device 603 is installed on an aerial mast within for example 50 km of the apartments.

If the electricity company wishes to know the consumption of a subscriber, it connects from its web based management system 612 to the server 611 which transmits the request to gateway device 603. Gateway device 603 then directly interrogates the required meter.

If the electricity company wishes to read all of the meters in a group of apartments it connects from its web based management system 612 to the server 611 which transmits the request to gateway device 603. Because gateway device 603 has a fixed IP address, the server can identify it and interrogate it directly at any time. Gateway device 603 interrogates successively the addresses of meters 601a, 601b and 601c, up to a maximum of e.g. 64000 addresses, then transmits all of the readings to server 611 which then communicates them to the company in IP form on its web based display 612.

Other applications of this overlay structure are possible. In particular the reading of meters 601a, 601b and 601c can be done automatically, without requiring a request from a user or the company. In this way, the meter readings registered by relay 603 and/or by the server 611 are updated regularly and posted on the web based display 612 and are quickly available to users.

Data monitors can be logging devices, temperature, movement or other measurement, devices. Meters can be for water, electricity, gas, or any other type of meters.

In a more general manner, the overlay structure described can be applied to the reading and centralization of all types of quantifiable information and all types of measurement.

In addition, the overlay structure can be applied to information concerning vehicles. For this, vehicles are equipped with radio-transmission capable of transmitting a radio signal containing the required information. Such a structure would permit the remote reading and collection of all kinds of information, for example the mileage of each vehicle, time of use, average speeds, condition of motor and other technical data, etc.

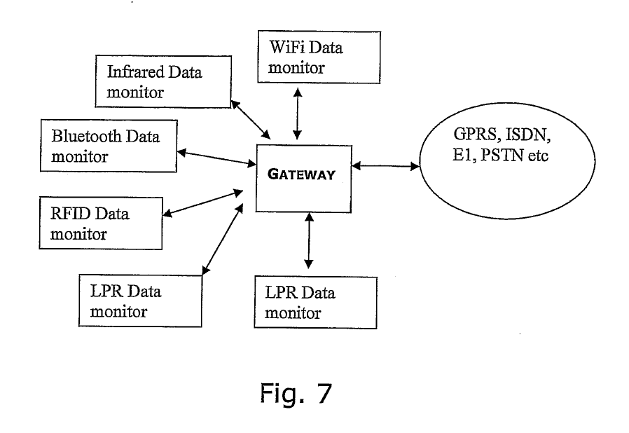

An embodiment of a gateway for the exemplary application is illustrated in FIG. 7. The Gateway is comprised of a computer, operating system & memory which are used to control, store and communicate with data monitors and the network for the transfer of the data. Using standard TCP/IP, UDP and other available protocols this gateway acts like a converter of one standard of input (WiFi, RFID, LPR, Infrared, Bluetooth, PSTN, etc) to a corresponding output. Within this process the data can be easily manipulated and processed.

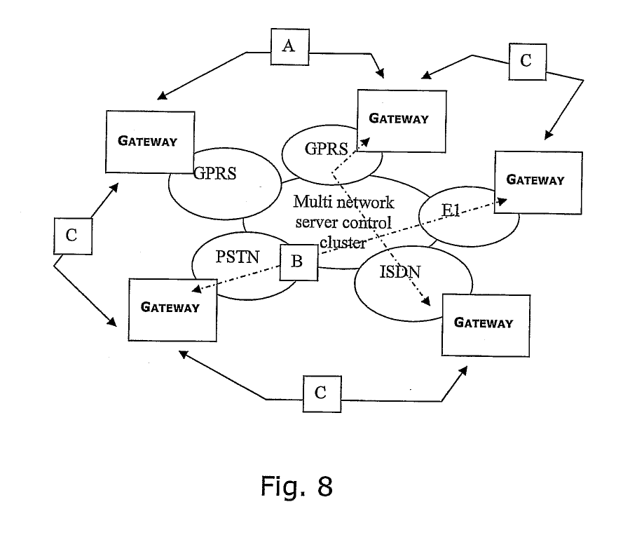

FIG. 8 shows how different gateways connected to the same common network through a cluster of servers that acts as the master control, storage and intelligence for the network. (A) shows how the same standard can be used to pass information and data, (B) shows how the gateways can communicate via the server cluster, (C) shows how the gateways can use different standards and still pull resources using other interfaces such as WiFi, GPRS or LPR. This mesh of gateways can be configured in a honeycomb manner, such as a cellular network. This will provide all of the existing advantages of cell sharing and seamless transfer from one cell to the next.

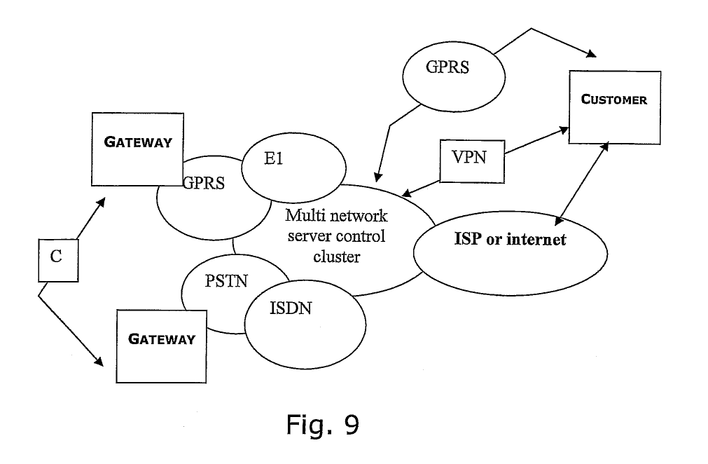

The customers, e.g. according to the above described example, wishing to view and interact with the data monitors can use either the internet using a dedicated cable access or through the GPRS or other mobile network or setup a dedicated VPN to the server cluster. The access is multifunctional and provides all of the required information and control. This is illustrated in FIG. 9.

While we have illustrated and disclosed preferred embodiments of the invention, it is obvious that more variations and modifications within the scope of the attached claims can occur.

1. A gateway device for connecting a number of incoming analogous and/or digital data inputs to a General Packet Radio Service (GPRS) based output, the gateway device comprising:
at least one analogous and/or digital data interface for interfacing said inputs,
a SIM card,
an instruction set memory,
a wireless transceiver,
means for storing, collating and managing data, and
means for converting input data to GPRS or fixed line data
wherein that the device further comprises means for receiving a fixed IP address or unique identity from a user.

2. The gateway device of claim 1, wherein said input is one or several of a group of PSTN or voice IP connection, a WiFi, Bluetooth, IR, LPR connection RS 232 or TCP/IP.

3. The gateway device of claim 1, wherein the device is a client/server device using an instruction set, which drives the GPRS or other type of device connected to a network

4. The gateway device of claim 1, comprising means for one or several of receiving, storing, collating, managing and retransmitting a number of simultaneous batches of data.

5. The gateway device of claim 4, wherein said data is provided from monitoring devices.

6. The gateway device of claim 5, wherein said monitoring devices comprises utility meters.

7. The gateway device of claim 1, comprising means for collecting data from a number of data monitoring devices in same or different signal formats and to interconnecting to one or several gateway devices and a server to create a data network over a wide geographical area.

8. The gateway device of claim 1, wherein the device is designed and optimized for sending and receiving data through a GPRS connection, in particular common mobile connections, being one or several of GSM, GPRS, CDMA, TDMA, ISDN, E1 and 10 baseT.

9. The gateway device of claim 1, wherein the device operates with fixed network connections.

10. The gateway device of claim 1, wherein the device installs a dedicated client instruction set in order to connect to other gateway devices, servers and the network.

11. The gateway device of claim 10, wherein the instruction set communicates with a network hub server and together they transform the way data is being handled, sent and received.

12. The gateway device of claim 10, wherein the instruction set comprises:
A reconfiguration part,
A compression part,
A selector part,
A transmission part,
An auto Restore function
A module for collecting, storing and managing data, and
A module for interconnection with other gateway devices.

13. The gateway device of claim 12, wherein said reconfiguration part is provided for reconfiguration of transport packets, their size and number.

14. The gateway device of claim 1, further comprising means for encrypting output data, and means for compressing data.

15. The gateway device of claim 14, wherein said compression part is provided for compressing and reducing the size of an actual transmitted data.

16. The gateway device of claim 10, wherein said selector part is provided for prioritizing content to be sent.

17. The gateway device of claim 12, wherein said selector part optimizes the use of time whilst connected by sending the smallest packets first and the largest files last.

18. The gateway device of claim 12, wherein said transmission part is provided for full duplex transmission.

19. The gateway device of claim 12, wherein said auto restore function is provided to monitor and control what data has been sent and to resend, where necessary, any data which may have been lost or corrupted in transit.

20. The gateway device of claim 12, further comprising means for encryption between two units through a communication channel.

21. The gateway device of claim 1, wherein the device comprises addition modules for enabling GPRS on a GSM network.

22. The gateway device of claim 21, wherein a first module is a Gateway GPRS Service Node (GGSN).

23. The gateway device of claim 21, wherein a second module is a Serving GPRS Service Node (SGSN).

24. The gateway device of claim 22, wherein the GGSN acts as a gateway between the GPRS network and Public Data Networks.

25. The gateway device of claim 23, wherein the SGSN provides packet routing to and from the SGSN service area for all users in that service area.

26. The gateway device of claim 1, comprising Packet Control Units, hosted in Base Station Subsystems, mobility management to locate a GPRS Mobile Station, an air interface for packet traffic, security features such as ciphering and GPRS specific signaling.

27. The gateway device of claim 1, comprising IP tunneling to encapsulate an IP datagram within IP datagrams, which allows datagrams destined for one IP address to be wrapped and redirected to another IP address.

28. The gateway device of claim 27, wherein an outer IP header is added before an original IP header, and between them are any other headers for the path, such as security headers specific to the tunnel configuration, the outer IP header Source and Destination identify the “endpoints” of the tunnel and an inner IP header Source and Destination identify the original sender and recipient of the datagram.

29. A network comprising many gateway device according to claim 1, which collects, stores, collates and retransmit data from a number of data monitoring devices to one or several of gateway devices and/or servers.

30. A server according for incorporation in a network according to claim 29 comprising means to allocate unique addresses to all gateway devices and subsequently to a number of data-monitoring devices to facilitate data management from every data monitoring device.

31. The server of claim 30, comprising means for interrogation by an end user to seek the data from all or any gateway device or any data monitoring device connected to the gateway device, to obtain current value measurements for control and management.

32. The server of claim 30, comprising means for automatically instructing all gateway devices to read measurement values of all data monitoring devices at given intervals to transmit data to an end user for control and management.

33. A method of assisting in the monitoring, management and conservation of data by combining a collection of data in a number of gateway devices according to claim 1 in different signal formats from one or several data monitoring devices, which are interconnected to one or several gateway devices and servers to create a data only network over a wide geographical area.

34. The method of claim 33, for a remote automated measuring system, the method comprising permitting the collection of value measurements from said data monitoring devices, transmitted to said gateway device by one of many different signals from transmitters attached to a number of utility meters, then stored, managed and retransmitted to a server by one of many different signals, e.g. GPRS.

35. The method of claim 33, further comprising other remote automated measuring systems, including vehicle telematics, monitoring of temperatures, movement, sound, security geofencing, surveillance from remote cameras and other measurable data values in order to improve other environmental and security issues of growing worldly importance.

36. A network comprising GPRS Device and a Server accessing a GPRS network using a dedicated link and/or Internet, wherein,
that the GPRS device comprises a SIM card and an application to provide security and compression when transmitting by means of a wireless device, the Server comprising costumer control devices loaded with corresponding applications to provide security and compression.

37. The network of claim 36 comprising means for transmitting data in IP form over Internet from the server to the customer in a manner which facilitates management from a web based display.

38. A method of connecting a number of incoming analogous and/or digital data inputs to a General Packet Radio Service (GPRS) based output, comprising the steps of: providing a device comprising:
at least one analogous and/or digital data interface for interfacing said inputs,
a SIM card, being a GPRS only enabled card and of a special series that has a higher priority of data transmission whilst on a network,
an instruction set memory,
a wireless transceiver, for transcieving said output data,
means for storing, collating, managing and retransmitting input data,
the method further comprising converting input data to GPRS data, encrypting output data, and compressing said output data.

39. A remote automated measuring system comprising a group of data monitors each equipped with radio transmitters capable of sending a radio signal containing measurement data and a server connected to a communications network, wherein
that the system comprises at least one gateway equipped with means for receiving radio signals from said monitors and transmitting said data to said server via a communication network, and then to a user in IP form and that said gateway further comprises means for receiving a fixed IP address or unique identity from a user.

40. The system of claim 39, wherein the information is managed on a web based display over the public Internet.
